(19) United States
(12) Patent Application Publication
(10) Pub. No.: US 2017/0126669 A1
(43) Pub. Date: May 4, 2017

(54) Hard drive management system and method thereof with network authentication function

(71) Applicant: APACER TECHNOLOGY INC., New Taipei City (TW)

(72) Inventor: Chih Hung Kuo, New Taipei City (TW)

(21) Appl. No.: 14/757,451

(22) Filed: Dec. 23, 2015

(30) Foreign Application Priority Data
Oct. 29, 2015 (TW) 104135519

(51) Int. Cl. H04L 29/06; G06F 12/14

(52) U.S. Cl. CPC H04L 63/0853; H04L 63/083; G06F 12/1408; H04L 63/061; G06F 2212/1052

(57) ABSTRACT

A hard drive management system and a method thereof with network authentication function are provided. The system includes a wireless router and a solid-state drive. The wireless router stores a key. The solid-state drive includes a storage module, a wireless network module and a control module. The storage stores the encrypted data. The wireless network module connects with the wireless router, and the wireless router receives the key. The control module electrically connects with the storage module and the wireless network module. The control module encrypts the source data to form the encrypted data according to the key of the wireless network module and stores the encrypted data in the storage module, or retrieves the encrypted data from the storage module and restores the encrypted data to form the source data according to the key.

### CROSS-REFERENCE TO RELATED APPLICATION

This application claims priority from Taiwan Patent Application No. 104135519, filed on Oct. 29, 2015, in the Taiwan Intellectual Property Office, the content of which is hereby incorporated by reference in their entirety for all purposes.

### BACKGROUND OF THE INVENTION

1. Field of the Invention

This application relates to a hard drive management system and a method thereof with network authentication function, and more particularly, to a hard drive management system and a method thereof with network authentication function applying the internet to transmit a key to encrypt and decrypt the data stored in the hard drive.

2. Description of the Related Art

Currently, the AES encryption of the solid-state drive is to arrange the AES key in the controller of the flash memory. When the solid-state drive is powered on, the AES key of the controller is applied to encrypt the data, so that the data stored in the flash memory can be encrypted by the AES key. However, such manner can only protect the data from being decrypted and accessed by the key of the controller when the flash memory of the solid-state drive is taken.

Another data encryption of the solid-state drive is to place the key in the computer host connected with the solid-state drive. When the data is written into the flash memory through the computer host, the data are encrypted by the key of the computer host, enabling the data stored in the computer host to form the encrypted data. However, utilizing a computer host to store the key cannot promote the data security because the data stored in the flash memory may still be misappropriated intentionally once the computer host and the solid-state drive are stolen together.

Therefore, the foregoing technical problems may be resolved by a hard drive management system and a method thereof with network authentication function provided by the inventor.

### SUMMARY OF THE INVENTION

In view of the foregoing technical problems, one objective of a hard drive management system and a method thereof with network authentication function of the present disclosure is to resolve the shortcomings of the data security concerning that the key is only stored in the controller.

In view of the foregoing technical problems, another objective of a hard drive management system and a method thereof with network authentication function of the present disclosure is to resolve the shortcomings of the data security concerning that the key is only stored in the computer host.

In accordance with aforementioned objective, the present disclosure provides a hard drive management system with network authentication function which may include a wireless router and a solid-state drive. The wireless router may store a key. The solid-state drive may include a storage module, a wireless network module and a control module. The storage module may store encrypted data. The wireless network module may connect with the wireless router, and the wireless router may receive the key. The control module may electrically connect with the storage module and the wireless network module. The control module may encrypt source data to form encrypted data according to the key of the wireless network module, and may store the encrypted data in the storage module. Alternatively, the control module may read the encrypted data from the storage module and then may restore the encrypted data to form the source data according to the key.

In accordance with aforementioned objective, the present disclosure provides a method with network authentication function adapted to a solid-stated hard drive. The solid-state drive may include a storage module, a wireless network module and a control module. The method with network authentication function may include the following steps: logging in the wireless router by the wireless network module; receiving the key from the wireless router and transmitting the key to the control module; and encrypting source data to form encrypted data according to the key and storing the encrypted data in the storage module, or reading the encrypted data in the storage module and restoring the encrypted data to form the source data according to the key.

As mentioned previously, a hard drive management system and a method thereof with network authentication function of the present disclosure may have one or more advantages as follows.

1. The flash memory of the solid-state drive cannot be decrypted only by the key of the controller, so that the data security of the solid-state drive is hereby strengthened.

2. Once the solid-state drive is accessed in an unallowable period, the electronic device applied in the present disclosure immediately transmits a stop signal to the control module, disabling the control module to encrypt and decrypt data. As a consequence, the data stored in the solid-state drive can avoid being accessed illegally.

### BRIEF DESCRIPTION OF THE DRAWINGS

FIG. 1 is a block diagram of the hard drive management system with network authentication function of the present disclosure.

FIG. 2 is the first schematic diagram illustrating the first embodiment of the hard drive management system with network authentication function of the present disclosure.

FIG. 3 is the second schematic diagram illustrating the first embodiment of the hard drive management system with network authentication function of the present disclosure.

FIG. 4 is the third schematic diagram illustrating the first embodiment of the hard drive management system with network authentication function of the present disclosure.

FIG. 5 is a flow chart of the hard drive management method with network authentication function of the present disclosure.

### DETAILED DESCRIPTION OF THE PREFERRED EMBODIMENTS

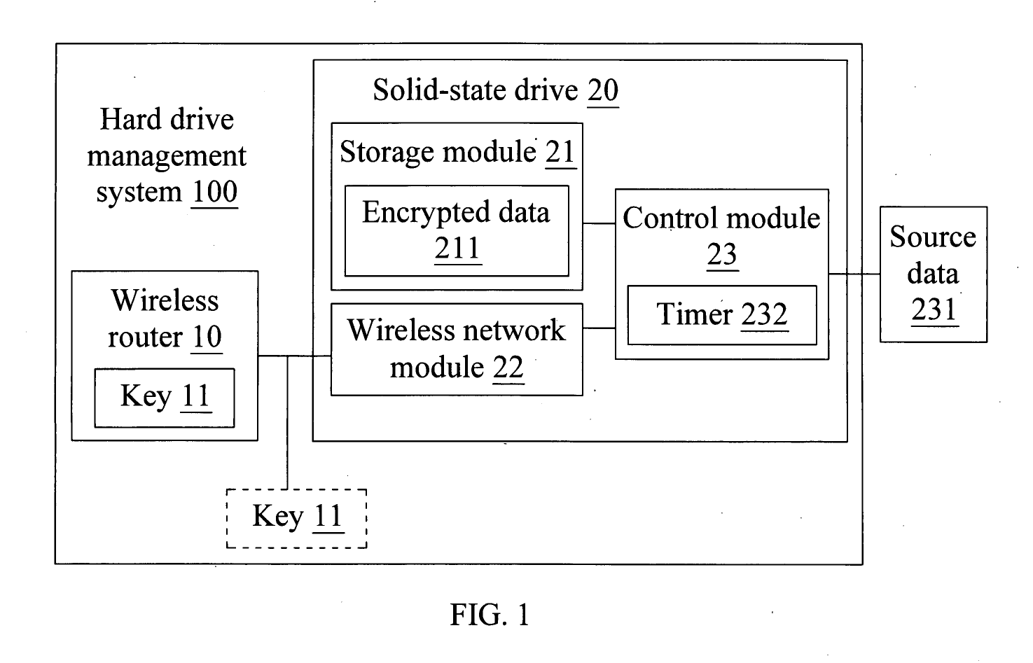

Please refer to FIG. 1, which is a block diagram of the hard drive management system with network authentication function of the present disclosure. As shown in the figure, a hard drive management system with network authentication function 100 includes a wireless router 10 and a solid-state drive 20. The wireless router 10 may be an embedded system and may enable the electronic device disposed with the networking chip to connect with an external interne. It is worth mentioning that the wireless router 10 of the present disclosure may store a predetermined key 11 in advance. The solid-state drive 20 is electrically connected to a computer host, a laptop or a workstation host, so that any of them can read and write the data of the solid-state drive 20.

The solid-state drive 20 includes a storage module 21, a wireless network module 22 and a control module 23. The storage module 21 includes a NAND flash memory and a DDR memory which are applied to store encrypted data 211. The wireless network module 22 includes a wireless networking chip which is applied to connect with the wireless router 10 and to receive the key 11 from the wireless router 10.

The control module 23 is a controller which is electrically connected to the storage module 21 and the wireless network module 22. The control module 23 integrates the central processor, memory, timer/counter and input/output interfaces. In the present embodiment, the control module 23 is electrically connected with the wireless network module 22 to receive the key 11. The key 11 is applied to encrypt source data 231 to form encrypted data 211 and to store the encrypted data 211 in the storage module 21. Alternatively, the key 11 is applied to restore the encrypted data 211 retrieved from the storage module 21 to form the source data 231.

In the present embodiment, the control module 23 further includes a timer 232 which is applied to produce time information about the wireless network module 22 connecting with the wireless router 10. The wireless network module 22 is automatically connected with the wireless router 10 when the solid-state drive 20 is powered on. As a result, the time information indicates each used time of the solid-state drive 20.

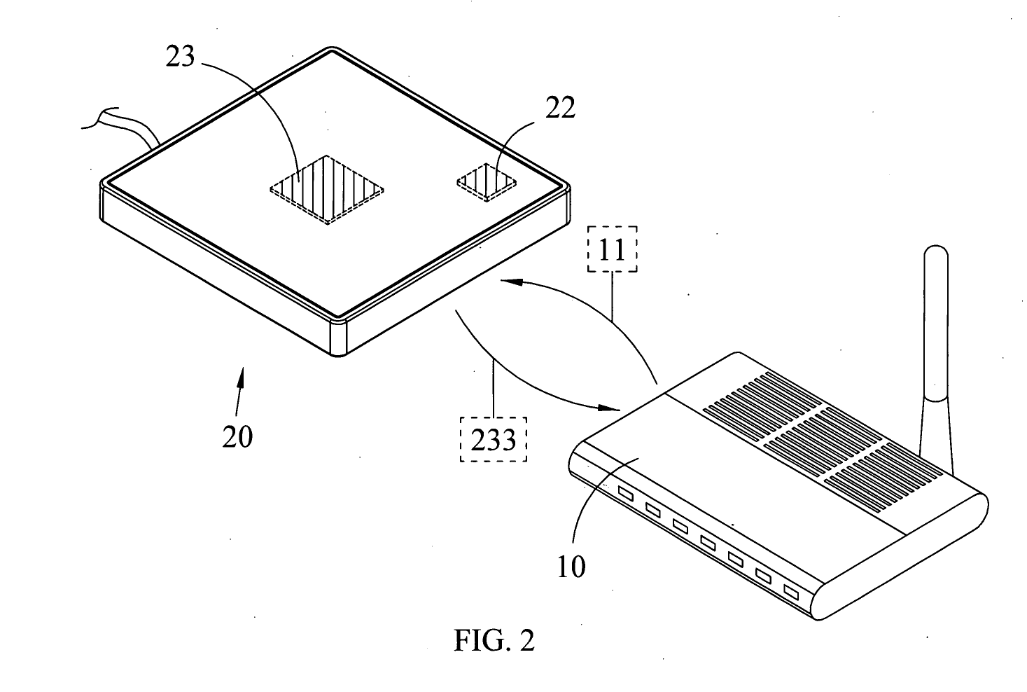

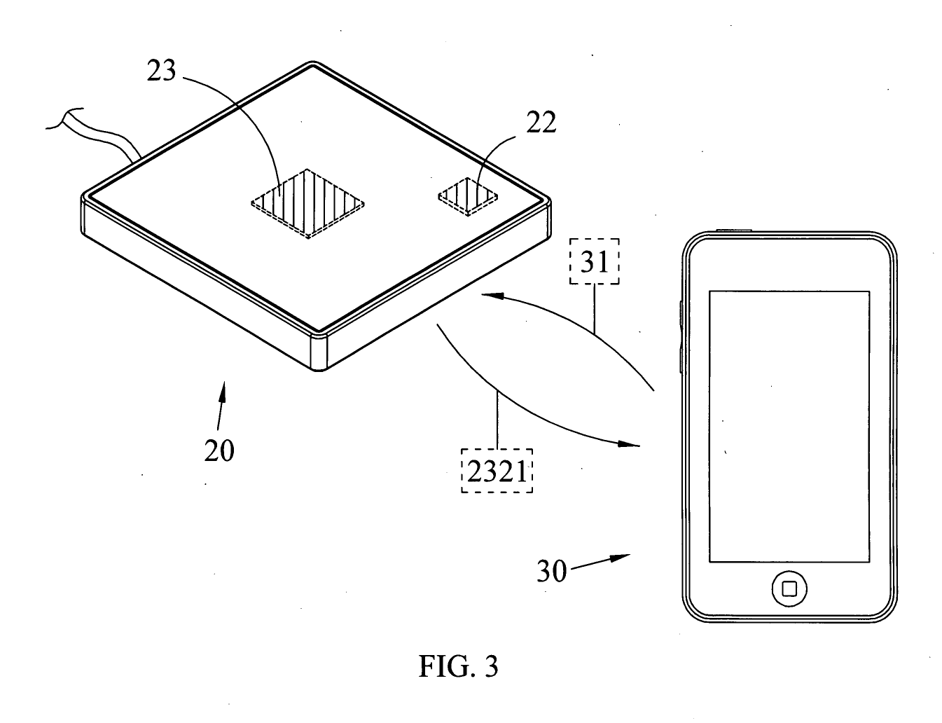

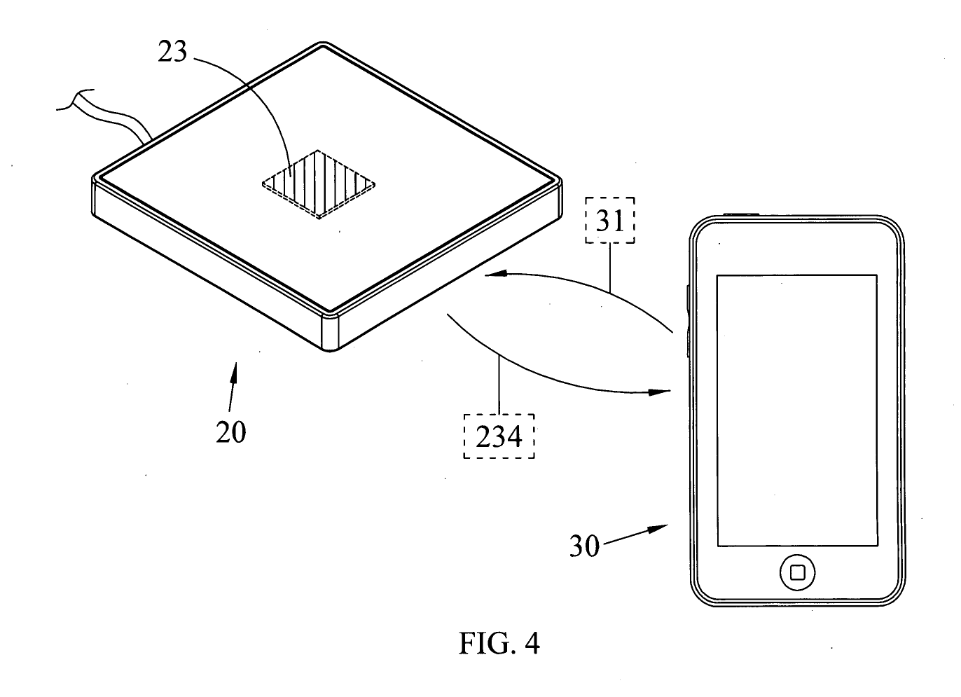

Please refer to FIG. 2, FIG. 3 and FIG. 4, which are the first, second and third schematic diagrams respectively illustrating the first embodiment of the hard drive management system with network authentication function of the present disclosure. Here, please refer to FIG. 1 together. As shown in FIG. 2, the solid-state drive 20 of the present embodiment is connected with a computer host (not shown in figures) through a SATA transmission line, and the computer host provides the solid-state drive 20 with the essential power for transmitting and calculating data.

In the present embodiment, the control module 23 is stored with a predetermined login password 233 in advance, enabling the wireless module 22 to login and then to connect with the wireless router 10 according to the predetermined login password 233. When the wireless router 10 confirms the predetermined login password 233 that is correct, the key 11 is sent to the wireless network module 22 of the solid-state drive 20. Here, the key 11 may be a public key and applies the symmetric encryption algorithms to encrypt and decrypt data. After receiving the key 11, the control module 23 encrypts the source data 231 transmitted from the computer host to form the encrypted data 211 and stores the encrypted data 211 in the storage module 21. Alternatively, when the user wants to read the content of the encrypted data 211 through the computer host, the control module 23 applies the key 11 to restore the encrypted data 211 stored in the storage module 21 to form the source data 231, and then transmits the source data 231 to the computer host.

Please refer to FIG. 3. The hard drive management system with network authentication function 100 further includes an electronic device 30 which may be a smartphone or a tablet. The electronic device 30 is applied to receive the time information 2321 of the timer (not shown in figures) about the connection. Here, the time information 2321 is embedded in a network packet and transmitted to the electronic device 30 through the wireless network module 22. Next, the electronic device 30 transmits a stop signal 31 to the wireless network module 22, and the control module 23 stops to restore the encrypted data 211 to form the source data 231 according to the stop signal 31, or stops to encrypt the source data 231 to form the encrypted data 211 according to the stop signal 31.

To be more precise, the control module 23 transmits a self-monitoring analysis and reporting technology (SMART) to the electronic device 30 through the wireless network module 22, facilitating the user to know the current condition of the solid-state drive 20 such as average reading/writing frequency, reading error rate, amount of irreparable damaged disk blocks, and track-seeing error rate, and so on. Once the condition is not good, the electronic device 30 also transmits the stop signal 31 to the wireless network module 22, immediately disabling the control module 23 to read and write the data stored in the solid-state drive 20, so that it can prevent the data stored in the solid-state drive 20 from the perpetual damage due to the damage to the storage module 30.

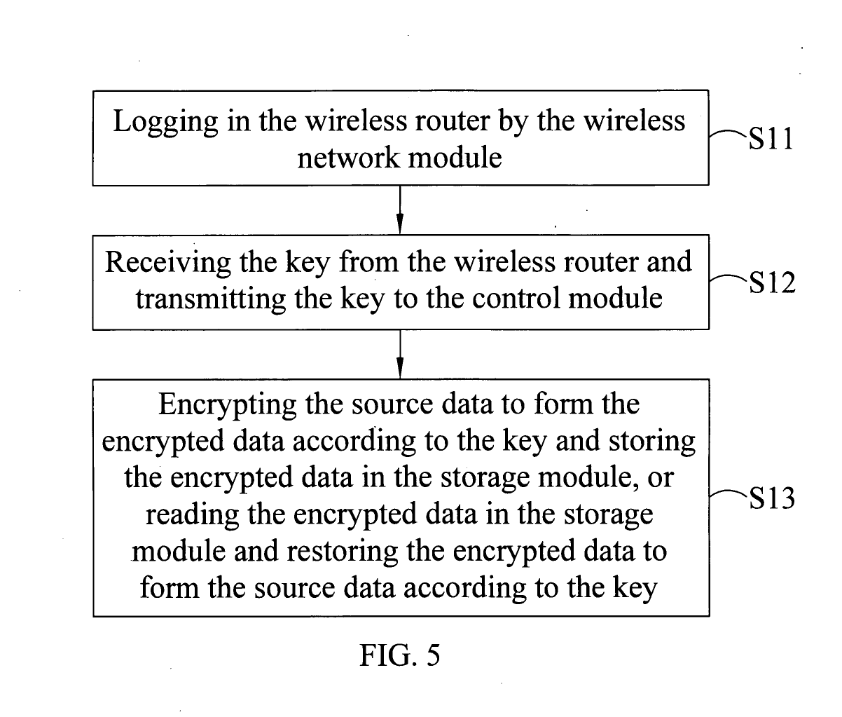

Please refer to FIG. 5, which is a flow chart of the hard drive management method with network authentication function of the present disclosure. As shown in the figure, a hard drive management method with network authentication function adapted to a solid-state drive includes a storage module, a wireless network module and a control module. The storage module includes a NAND flash memory and a DDR memory. The wireless network module includes a wireless networking chip. The control module includes a controller which is electrically connected to the storage module and the wireless network module. The hard drive management method with network authentication function includes the following step.

Step S11: Logging in the wireless router by the wireless network module;

Step S12: Receiving the key from the wireless router and transmitting the key to the control module; wherein, the key may be a public key having the symmetric encryption algorithms, and

Step S13: Encrypting source data to form encrypted data according to the key and storing the encrypted data in the storage module, or reading the encrypted data in the storage module and restoring the encrypted data to form the source data according to the key.

In the step S11, a predetermined login password is further stored in the control module, so that the wireless network module logins and then connects with the wireless router according to the predetermined login password. Here, the predetermined login password may be a text format password, and it may be an IP address among a specific IP range. For example, a specific IP range is 192.168.1.1-492.168.1.254 and any IP in that range is allowed to login and connect with the wireless router. In other words, when the wireless router receives the internet packet of the wireless network module which desires to login, it can determine whether the requirement for logging in and connecting is accepted according to the source IP address of the internet packet. By such manner, the solid-state drive of the present embodiment can only obtain the key from the wireless router through partial zones. For example, it can only obtain the key from the wireless router arranged in the specific office. Once the solid-state drive is not in the specific office, it cannot obtain the key to encrypt and decrypt the data stored in the solid-state drive.

Preferably, the control module further includes a timer, so that the control module can apply the time information about the wireless network module connecting with the wireless router produced by the timer. In addition, the electronic device receives the time information produced by the timer and transmits a stop signal to the wireless network module. The control module stops to restore the encrypted data to form the source data according to the stop signal. Alternatively, the electronic device transmits a stop signal to wireless network module and the control module stops to encrypt the source data to form the encrypted data according to the stop signal.

According to description mentioned previously, it can be found that the hard drive management system with network authentication function of the present embodiment is capable of providing the solid-state drive with the key through Wi-Fi, enabling that when the solid-state drive is misusing, the data security is not affected. In addition, when the solid-state drive is misusing, the present disclosure is capable of notifying the electronic device through interne, and then the electronic device transmits the stop signal to stop to encrypting and decrypting the data stored in the solid-state drive, so as to achieve the purpose of real-time monitoring.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A hard drive management system with network authentication function, comprising:
a wireless router storing a key; and
a solid-state drive, comprising:
a storage module storing encrypted data;
a wireless network module connecting to the wireless route, and the wireless router receiving the key, and
a control module electrically connected to the storage module and the wireless network module, the control module encrypting source data to form the encrypted data according to the key of the wireless network module and then storing the encrypted data in the storage module, or retrieving the encrypted data from the storage module and restoring the encrypted data to form the source data according to the key.

2. The hard drive management system with network authentication function of claim 1, wherein the control module comprises a timer producing time information about the wireless network module connecting with the wireless router.

3. The hard drive management system with network authentication function of claim 2, further comprising an electronic device receiving the time information of the timer and transmitting a stop signal to the wireless network module according to the time information, and the control module stopping restoring the encrypted data to form the source data according to the stop signal.

4. The hard drive management system with network authentication function of claim 1, further comprising an electronic device, and the control module transmitting a self-monitoring analysis and reporting technology (SMART) to the electronic device through the wireless network module.

5. The hard drive management system with network authentication function of claim 1, wherein the control module stores a predetermined login password, and the wireless network module logins and then connects to the wireless router according to the predetermined login password.

6. The hard drive management system with network authentication function of claim 1, wherein the storage module comprises a NAND flash memory and a DDR memory.

7. A hard drive management method with network authentication function adapted to a solid-state drive, the solid-state drive comprising a storage module, a wireless network module and a control module, and the hard drive management method comprising:
logging in a wireless router by the wireless network module;
receiving a key from the wireless router and transmitting the key to the control module; and
encrypting source data to form encrypted data according to the key and storing the encrypted data in the storage module, or reading the encrypted data in the storage module and restoring the encrypted data to form the source data according to the key.

8. The hard drive management method with network authentication function of claim 7, further comprising storing a predetermined login password in the control module, and the wireless network module logging in and then connecting with the wireless router according to the predetermined login password.

9. The hard drive management method with network authentication function of claim 7, wherein the control module comprises a timer.

10. The hard drive management method with network authentication function of claim 9, further comprising time information produced by the timer about the wireless network module connecting with the wireless router.

11. The hard drive management method with network authentication function of claim 10, further comprising an electronic device receiving the time information of the timer and transmitting a stop signal to the wireless network module according to the time information, and the control module stopping restoring the encrypted data to form the source data according to the stop signal.

12. The hard drive management method with network authentication function of claim 10, further comprising an electronic device receiving the time information of the timer and transmitting the stop signal to the wireless network module according to the time information, and the control module stopping encrypting the source date to form the encrypted data according to the stop signal.
